(19) United States
(12) Patent Application Publication
(10) Pub. No.: US 2025/0392398 A1
(43) Pub. Date: Dec. 25, 2025

(54) RADIO FREQUENCY EXPOSURE COMPLIANCE AMONG RADIOS IN REDUCED POWER MODE

(71) Applicant: QUALCOMM Incorporated, San Diego, CA (US)

(72) Inventors: Saurabh JAIN, Hyderabad (IN); Chinamay KUMAR, Hyderabad (IN); Shaikh ASFAQUZ ZAMAN, Hyderabad (IN); Sougat RAY, Hyderabad (IN)

(21) Appl. No.: 18/747,919

(22) Filed: Jun. 19, 2024

(51) Int. Cl. H04B 17/10; H04W 52/22

(52) U.S. Cl. CPC H04B 17/102; H04W 52/228

(57) ABSTRACT

Certain aspects of the present disclosure provide techniques and apparatus for operating a wireless communication device pursuant to radio frequency (RF) exposure compliance. An example method of wireless communication includes monitoring transmit power usage of a radio of the wireless device during a time interval in which the wireless device is in a reduced power mode. The transmit power usage over a first portion of the time interval is determined to satisfy one or more first criteria associated with lack of compliance with an RF exposure limit, based on the monitoring. Responsive to the determination, the radio is controlled during a second portion of the time interval in compliance with the RF exposure limit based at least in part on the transmit power usage over the first portion of the time interval.

### BACKGROUND

### FIELD OF THE DISCLOSURE

Aspects of the present disclosure relate to wireless communications, and more particularly, to providing radio frequency (RF) exposure compliance among one or more radios operating in a wireless communication device.

### DESCRIPTION OF RELATED ART

Wireless communication systems are widely deployed to provide various telecommunication services such as telephony, video, data, messaging, broadcasts, etc. Modern wireless communication devices (such as cellular telephones) are generally mandated to meet radio frequency (RF) exposure limits set by certain governments and international standards and regulations. To ensure compliance with the standards, such devices may undergo an extensive certification process prior to being shipped to market. To ensure that a wireless communication device complies with an RF exposure limit, techniques have been developed to enable the wireless communication device to assess RF exposure from the wireless communication device and adjust the transmission power of the wireless communication device accordingly to comply with the RF exposure limit.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide advantages that include maintaining radio frequency (RF) exposure compliance during a reduced power mode of a wireless device.

Certain aspects of the subject matter described in this disclosure can be implemented in a method for wireless communication by a wireless device. The method generally includes monitoring transmit power usage of a radio of the wireless device during a time interval, wherein the wireless device is in a reduced power mode during the time interval. The method also includes determining, based on the monitoring, that the transmit power usage over a first portion of the time interval satisfies one or more first criteria associated with lack of compliance with a radio frequency (RF) exposure limit. The method further includes, responsive to the determination, controlling the radio during a second portion of the time interval in compliance with the RF exposure limit based at least in part on the transmit power usage over the first portion of the time interval.

Certain aspects of the subject matter described in this disclosure can be implemented in an apparatus for wireless communication. The apparatus includes one or more memories collectively storing computer-executable instructions, and one or more processors coupled to the one or more memories. The one or more processors are collectively configured to execute the computer-executable instructions to cause the apparatus to: monitor transmit power usage of a radio of the apparatus during a time interval, wherein the apparatus is in a reduced power mode during the time interval; determine, based on the monitoring, that the transmit power usage over a first portion of the time interval satisfies one or more first criteria associated with lack of compliance with a radio frequency (RF) exposure limit; and responsive to the determination, control the radio during a second portion of the time interval in compliance with the RF exposure limit based at least in part on the transmit power usage over the first portion of the time interval.

Certain aspects of the subject matter described in this disclosure can be implemented in an apparatus for wireless communication. The apparatus generally includes means for monitoring transmit power usage of a radio of the apparatus during a time interval, wherein the apparatus is in a reduced power mode during the time interval. The apparatus also includes means for determining, based on the monitoring, that the transmit power usage over a first portion of the time interval satisfies one or more criteria associated with lack of compliance with a radio frequency (RF) exposure limit. The apparatus further includes means for controlling, responsive to the determination, the radio during a second portion of the time interval in compliance with the RF exposure limit based at least in part on the transmit power usage over the first portion of the time interval.

Certain aspects of the subject matter described in this disclosure can be implemented in a computer-readable medium. The computer-readable medium has instructions stored thereon for performing an operation. The operation includes monitoring transmit power usage of a radio of the wireless device during a time interval, wherein the wireless device is in a reduced power mode during the time interval. The operation also includes determining, based on the monitoring, that the transmit power usage over a first portion of the time interval satisfies one or more first criteria associated with lack of compliance with a radio frequency (RF) exposure limit. The operation further includes responsive to the determination, controlling the radio during a second portion of the time interval in compliance with the RF exposure limit based at least in part on the transmit power usage over the first portion of the time interval.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication system exhibiting radio frequency (RF) exposure to a human, in accordance with certain aspects of the present disclosure.

FIG. 2 is a block diagram conceptually illustrating a design of an example wireless communication device communicating with another device, in accordance with certain aspects of the present disclosure.

FIG. 3 is a graph illustrating examples of transmit powers over time in compliance with an RF exposure limit, in accordance with certain aspects of the present disclosure.

FIG. 4A is a diagram illustrating an example wireless device having multiple radios, in accordance with certain aspects of the present disclosure.

FIG. 4B is a diagram illustrating an example logical architecture for controlling the RF exposure associated with one or more radios, in accordance with certain aspects of the present disclosure.

FIG. 5 is a flow diagram illustrating example operations for RF exposure compliance when a wireless device is in a reduced power mode, in accordance with certain aspects of the present disclosure.

FIG. 6 is a diagram illustrating an example RF exposure compliance over time when a wireless device is in a reduced power mode, in accordance with certain aspects of the present disclosure.

FIG. 7 is a diagram illustrating an example of improved RF exposure compliance over time when a wireless device is in a reduced power mode, in accordance with certain aspects of the present disclosure.

FIG. 8 is a flow diagram illustrating example operations for wireless communication by a wireless device, in accordance with certain aspects of the present disclosure.

FIG. 9 illustrates a communications device (e.g., a user equipment (UE)) that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer-readable mediums for providing radio frequency (RF) exposure compliance among one or more radios operating in a wireless device while the wireless device is in a reduced power mode.

For example, a wireless device may be capable of communicating via multiple radio access technologies (RATs), such as wireless wide area network (WWAN) RAT(s) (e.g., 5G New Radio (NR), Evolved Universal Terrestrial Radio Access (E-UTRA), Universal Mobile Telecommunications System (UMTS) and/or code division multiple access (CDMA)), wireless local area network (WLAN) RATs (e.g., Institute of Electrical and Electronics Engineers (IEEE) 802.11), short-range communications (e.g., Bluetooth), non-terrestrial communications, device-to-device (D2D) communications, vehicle-to-everything (V2X) communications, and/or other communications (e.g., future RAT(s)). In some cases, the wireless device may control RF exposure using a primary controller that controls the transmit power (and hence, the RF exposure) associated with particular radios for one or more RATs.

When the wireless device is in a normal mode (or state), the primary controller may manage RF exposure of the one or more radios of the wireless device for a (running) time window in compliance with an RF exposure limit (e.g., time-averaged RF exposure limit). For example, the primary controller may provide a respective transmit power limit to each of the radios that applies for a specific time interval of the (running) time window, in compliance with the RF exposure limit. In some cases, compliance with the RF exposure limit may be performed as a time-averaged RF exposure evaluation within a specified running (moving) time window associated with the RF exposure limit.

In some cases, the primary controller may not be able to communicate with the radio(s) of the wireless device when the wireless device is in a reduced power mode. One example of such a reduced power mode is wake-on-wireless (also known as wake-on-WLAN) (WoW) mode. In WoW mode, the wireless device may operate in a reduced power mode (or state), in which certain functionality of the wireless device may be disabled in order to save power. For example, there may not be an active communication link between the primary controller and the radio(s) of the wireless device that the primary controller can use to re-budget the power utilization of the radio(s) at regular intervals of time (e.g., over the running (moving) time window associated with the RF exposure limit).

When the wireless device is in the reduced power mode, the radio(s) of the wireless device may apply a fixed RF exposure budget (e.g., a fixed transmission power budget). The primary controller may provide the fixed RF exposure budget to the radio(s) prior to the wireless device entering the reduced power mode. The fixed RF exposure budget may apply for one or more time intervals in which the wireless device is in the reduced power mode. For example, the primary controller may provide a respective fixed power budget (e.g., X% of RF exposure limit) for each radio to consume within a particular time interval.

The wireless device may transition from the reduced power mode (e.g., WoW mode) to the normal mode in response to detecting one or more wake conditions (or triggers), such as a disconnect, reception of a “magic” wake packet, failure of a rekey operation, or reception of an incoming transmission control protocol (TCP) packet, as illustrative, non-limiting examples. Thus, in the reduced power mode, one or more radios may perform certain activities (e.g., listening/responding to packets, etc.) to determine when a wake condition (or trigger) is present.

In some cases, however, certain activities of the radio(s) may cause the radio(s) to have reduced performance when the wireless device is in the reduced power mode. Consider an example scenario in which one or more first radios of the wireless device are receiving and responding to multiple frames from different devices while the wireless device is in a reduced power mode (e.g., WoW mode). In such a scenario, the communication activity of the first radio(s) of the wireless device may exceed the fixed RF exposure budget allocated to the first radio(s) for a particular time interval during the reduced power mode operation. In some cases, exceeding the fixed RF exposure budget for the time interval may affect the wireless communication performance of the first radio(s) for at least a remaining portion of the time interval. For example, the first radio(s) may have reduced throughput, increased latency, decreased transmission range, and/or may not be able to transmit for a remaining portion of the time interval, as illustrative, non-limiting examples.

Additionally or alternatively, in some cases, certain activities of the radio(s) may cause the wireless device to violate RF exposure compliance when the wireless device is in the reduced power mode. Continuing with the above example scenario, if one or more second radio(s) of the wireless device are transmitting in the same time interval in which the first radio(s) have exceeded the fixed RF exposure budget, the overall transmit power usage of the first and second radio(s) may exceed the RF exposure limit, violating RF exposure compliance.

Additionally or alternatively, in some cases, for wireless devices that support multi-link operation (MLO), the MLO functionality of the wireless device may cause the wireless device to violate RF exposure compliance when the wireless device is in the reduced power mode. As described in greater detail below, MLO supports establishing multiple different communication links (such as a first link on the 2.4 gigahertz (GHz) band, a second link on the 5 GHz band, and a third link on the 6 GHz band, as an illustrative example). MLO link selection or link switching may be performed based on metrics generally associated with link failure and/or link quality, such as packet error rate (PER), link utilization, traffic types, traffic rates, and queue occupancy, as illustrative examples. For example, when a given communication link of a radio satisfies a predetermined condition (e.g., link quality is below a threshold), then the wireless device may switch to a different communication link on the same or different radio for communications.

However, when the wireless device is in the reduced power mode (e.g., WoW mode), the MLO link switching may result in the wireless device selecting or switching to a communication link with activity that causes the radio(s) associated with that link to have reduced performance (e.g., reduced throughput, increased latency, decreased transmission range, etc.). For example, the communication activity on the communication link that the wireless device selects or switches to may exceed the fixed RF exposure budget allocated to the first radio(s) of the wireless device for a particular time interval during the reduced power mode operation. As noted, exceeding the fixed RF exposure budget for the time interval may affect the wireless communication performance of the first radio(s) for at least a remaining portion of the time interval. In other examples, if one or more second radio(s) of the wireless device are transmitting in the same time interval in which the selected communication link of the first radio(s) has exceeded the fixed RF exposure budget, then the overall transmit power usage of the first and second radio(s) may exceed the RF exposure limit, violating RF exposure compliance.

Aspects of the present disclosure provide apparatus and methods for providing RF exposure compliance among one or more radios operating in a wireless device while the wireless device is in a reduced power mode, such as a WoW mode. In certain aspects, the wireless device may monitor transmit power usage of one or more radios of the wireless device when the wireless device is in the reduced power mode (e.g., WoW mode). In certain aspects, the wireless device may monitor transmit power usage of one or more communication links associated with one or more radios of the wireless device when the wireless device is in the reduced power mode. The wireless device may determine that a given one or more radios, one or more communication links of one or more radios, or a combination thereof, satisfy certain criteria associated with lack of compliance with an RF exposure limit during the reduced power mode. For example, the criteria may include a determination that there is unlikely to be a sufficient amount of power reserved for future communications during the time interval in which the wireless device is in the reduced power mode, a determination that the power usage over a past portion of the time interval (in relation to how much time of the time interval has elapsed) is disproportionate, or a combination thereof.

In response to determining that a given one or more radios, a given one or more communication links of one or more radios, or a combination thereof, satisfy the criteria associated with lack of compliance with the RF exposure limit during the reduced power mode, the wireless device may perform one or more actions to reduce the transmit power usage of the communication link(s), the radio(s), or a combination thereof, while the wireless device is in the reduced power mode. The action(s) may include, for example, refraining from responding to one or more types of packets (e.g., multicast packets, broadcast packets, etc.) via the radio(s), reducing a transmission power used for transmitting one or more packets via the radio(s), reducing a duty cycle of a transmitter of the wireless device, evaluating other communication links that can be used for transmission activity with lower transmit power, selecting or switching to one or more of the other links, based on the evaluation, reducing a duty cycle of a transmitter of the wireless device for the new communication link that has been selected or switched to, or a combination thereof.

The apparatus and methods for providing RF exposure compliance among one or more communication links and/or radios of a wireless device while the wireless device is in a reduced power mode may provide various advantages. For example, performing actions to reduce the transmit power usage of communication link(s)/radio(s) when certain criteria are satisfied may allow certain communication links/radios to transmit RF signals in compliance with RF exposure limits when the wireless device is in the reduced power mode, allow certain communication links/radios to improve wireless communication performance (e.g., increased throughput, decreased latency, and/or increased transmission range) when the wireless device is in the reduced power mode, allow the wireless device to avoid violations of RF exposure compliance when the wireless device is in the reduced power mode, or combinations thereof.

While certain description herein relates to a primary controller or a link with a primary controller being unavailable, described aspects may be utilized in systems in which there is no primary controller or in which communication with a primary controller is irrelevant. For example, the actions described in the previous paragraph (and in additional detail below) may be performed by a radio that manages its own RF exposure compliance, e.g., in a system in which a controller separate from the radio does not manage the radio’s compliance. Such radio may be disposed in a device operating in a reduced power mode. In other examples, aspects described herein may be performed by one or more radios disposed in a device which is not operating in a reduced power mode. For example, strategies for monitoring transmit power usage and/or reducing transmit power usage described in the preceding paragraphs (and in additional detail below) may be utilized by one or more radios managing RF exposure compliance when the RF exposure budget has been fixed for a portion of time, e.g., when a primary controller allocates a fixed budget to a radio for a length of time, regardless of whether a reduced power mode is being used. In other aspects, a fixed RF exposure budget is not required.

The following description provides examples of RF exposure compliance, for example when a wireless device is in a reduced power mode, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs, or may support multiple RATs.

As used herein, a radio may refer to a physical or logical transmission path associated with one or more frequency bands (carriers, channels, bandwidths, subdivisions thereof, etc.), transmitters (or transceivers), and/or RATs (e.g., WWAN, WLAN, short-range communications (e.g., Bluetooth), non-terrestrial communications, D2D communications, V2X communications, etc.) used for wireless communications. For example, for uplink carrier aggregation (or multi-connectivity) in WWAN, each of the active component carriers used for wireless communications may be treated as a separate radio. Similarly, multi-band transmissions for IEEE 802.11 may be treated as separate radios for each frequency band (e.g., 2.4 GHz, 5 GHz, and/or 6 GHz). In some examples, a radio is defined based on a RAT, frequency, and/or operation controlled by an inner loop (or equivalent when an outer loop is not operational or applicable) for the purposes of RF exposure determination and/or RF exposure compliance.

The techniques described herein may be used for various wireless networks and radio technologies. While aspects may be described herein using terminology commonly associated with 3G, 4G, and/or 5G (e.g., 5G NR) wireless technologies, aspects of the present disclosure can be applied in other generation-based communication systems and/or to wireless technologies such as IEEE 802.11, 802.15, etc.

Example Wireless Communication Network and Devices

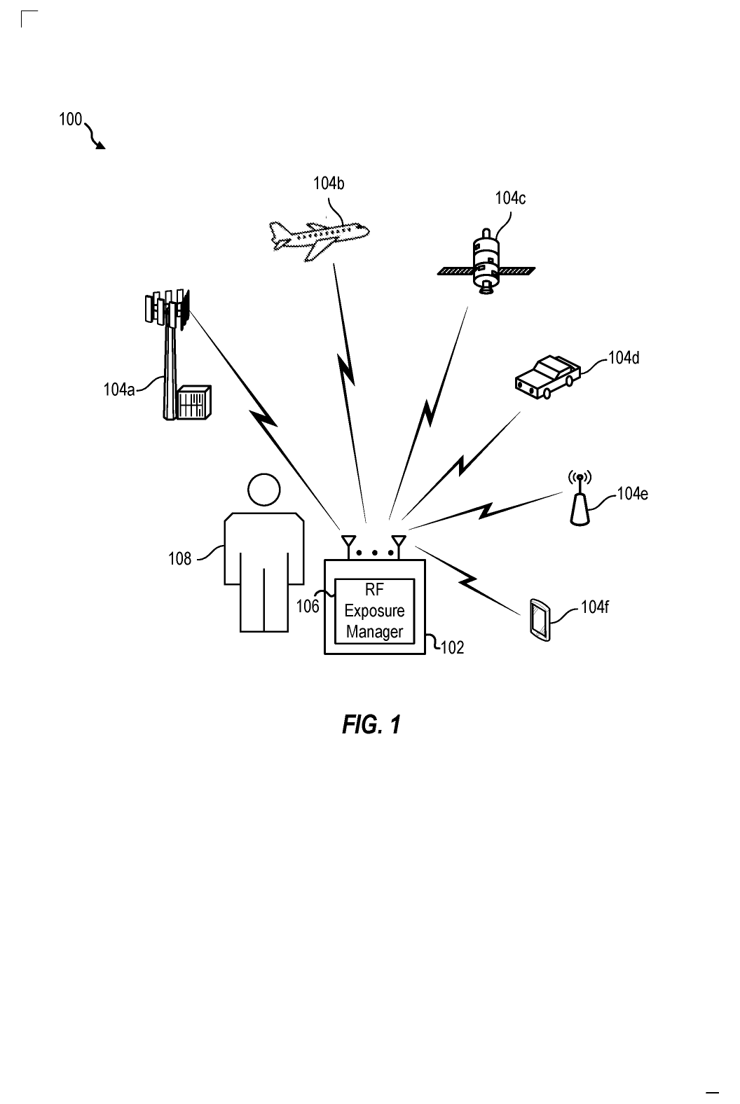

FIG. 1 illustrates an example wireless communication system 100 in which aspects of the present disclosure may be performed. For example, the wireless communication system100 may include a wireless wide area network (WWAN) and/or a wireless local area network (WLAN). For example, a WWAN may include a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation (2G)/Third Generation (3G) network), a code division multiple access (CDMA) system (e.g., a 2G/3G network), any future WWAN system, or any combination thereof. A WLAN may include a wireless network configured for communications according to an IEEE standard such as one or more of the 802.11 standards, etc. In some cases, the wireless communication system 100 may include a device-to-device (D2D) communications network or a short-range communications system, such as Bluetooth communications.

As illustrated in FIG. 1, the wireless communication system 100 may include a wireless device 102 communicating with any of various wireless devices 104a-104f (a wireless device 104) via any of various radio access technologies (RATs), where a wireless device may refer to a wireless communication device. The RATs may include, for example, WWAN communications (e.g., E-UTRA and/or 5G NR), WLAN communications (e.g., IEEE 802.11), vehicle-to-everything (V2X) communications, non-terrestrial network (NTN) communications, short-range communications (e.g., Bluetooth), etc.

The wireless device 102 may be emitting RF signals in proximity to a human 108, who may be the user of the wireless device 102 and/or a bystander. As an example, the wireless device 102 may be held in the hand of the human 108 and/or positioned against or near the head of the human 108. In certain cases, the wireless device 102 may be positioned in a pocket or bag of the human 108. In some cases, the wireless device 102 may positioned proximate to the human 108 as a mobile hotspot. To ensure the human 108 is not overexposed to RF emissions from the wireless device 102, the wireless device 102 may control the transmit power associated with the RF signals in accordance with an RF exposure limit, as further described herein, where the RF exposure limit may depend on the corresponding exposure scenario (e.g., head exposure, hand (extremity) exposure, body (body-worn) exposure, hotspot exposure, etc.).

The wireless device 102 may include any of various wireless communication devices including a user equipment (UE), a wireless station, an access point (AP), a customer-premises equipment (CPE), etc. In certain aspects, the wireless device 102 includes an RF exposure manager 106 that manages the RF exposure associated with one or more radios in compliance with an RF exposure limit when the wireless device 102 is in a reduced power mode (e.g., WoW mode), in accordance with aspects of the present disclosure.

The wireless devices 104a-104f may include, for example, a base station 104a, an aircraft 104b, a satellite 104c, a vehicle 104d, an access point 104e, and/or a UE 104f. Further, the wireless communication system 100 may include terrestrial aspects, such as ground-based network entities (e.g., the base station 104a and/or access point 104e), and/or non-terrestrial aspects, such as the aircraft 104b and the satellite 104c, which may include network entities on-board (e.g., one or more base stations) capable of communicating with other network elements (e.g., terrestrial base stations) and/or user equipment.

The base station 104a may generally include: a NodeB (NB), enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always-on (AON) devices, edge processing devices, or other similar devices. A UE may also be referred to more generally as a mobile device, a wireless device, a wireless communications device, a station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

In certain cases, the wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless communication devices using transmission frequencies above 6 GHz. Frequency bands of 24 GHz to 71 GHz are sometimes referred to as a “millimeter wave” (“mmW” or “mmWave”). The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as 2G/3G (e.g., CDMA), 4G (e.g., E-UTRA), 5G (e.g., NR in sub-6 GHz bands), IEEE 802.11(e.g., a/b/g/n/ac), etc. PD may be used to assess RF exposure for transmission frequencies higher than 6 GHz, which cover wireless communication technologies such as IEEE 802.11ad, 802.11ay, 5G in mmWave bands, etc. Thus, different metrics may be used to assess RF exposure for different wireless communication technologies.

A wireless device (e.g., the wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHz (e.g., 3G, 4G, 5G, 802.11a/b/g/n/ac, etc.) and a second wireless communication technology operating above 6 GHz (e.g., mmWave 5G in 24 to 60 GHz bands, IEEE 802.11ad or 802.11ay). In certain aspects, the wireless device may transmit signals using the first wireless communication technology (e.g., 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD. As used herein, sub-6 GHz bands may include frequency bands of 300 megahertz (MHz) to 6,000 MHz in some examples, and may include bands in the 6,000 MHz and/or 7,000 MHz range in some examples.

Some wireless devices (including both wireless devices 102 and 104) are capable of multi-link operation (MLO). In some examples, MLO supports establishing multiple different communication links (such as a first link on the 2.4 GHz band, a second link on the 5 GHz band, and a third link on the 6 GHz band) between wireless devices, such as an AP and a STA. Each communication link may support one or more sets of channels or logical entities. In some cases, each communication link associated with a given wireless device may be associated with a respective radio of the wireless device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs each configured to communicate on a respective communication link with a respective one of multiple STAs of a non-AP MLD (also referred to as a “STA MLD”). The STA MLD may communicate with the AP MLD over one or more of the multiple communication links at a given time.

An MLD may generally be classified based on whether the MLD is a single radio MLD or multi-radio MLD. Single radio MLDs generally use a single radio to switch between one or more communication links. One category of single radio MLDs is enhanced multi-link single radio (eMLSR). eMLSR devices generally operate one main wireless radio that can transmit and/or receive data frames on a given communication link, but can detect some data (e.g., short initial frames) on a set of other communication links when the device is not actively transmitting or receiving. Another category of single radio MLDs is multi-link single radio (MLSR). Similar to eMLSR devices, MLSR devices generally operate one main wireless radio that can transmit and/or receive data frames on a given communication link. However, compared to eMLSR devices, MLSR devices may be incapable of detecting data on a set of other communication links when the device is not actively transmitting or receiving.

Multi-radio MLDs may generally be classified into the following two types: (i) simultaneous transmission and reception (STR) MLD and (ii) non-STR MLD. For STR MLDs, a transmission on one link may not affect the operations of frame reception and clear channel assessment (CCA) on other links. Stated differently, for STR MLDs, individual communication links can operate independently of each other. For non-STR MLDs, operation on one communication link may be restricted by operation on another communication link. For example, a transmission on one communication link may not be allowed if such a transmission will cause reception interruption on another communication link. In another example, a reception or CCA on one communication link may not be allowed if a transmission is ongoing on another communication link.

One type of MLO is multi-link aggregation (MLA), where traffic associated with a single STA is simultaneously transmitted across multiple communication links in parallel to maximize the utilization of available resources to achieve higher throughput. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications, and one or more links may support downlink communications. In such examples, at least one of the wireless devices operates in a full duplex mode. Generally, full duplex operation enables bi-directional communications where at least one of the wireless devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which the AP MLD transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

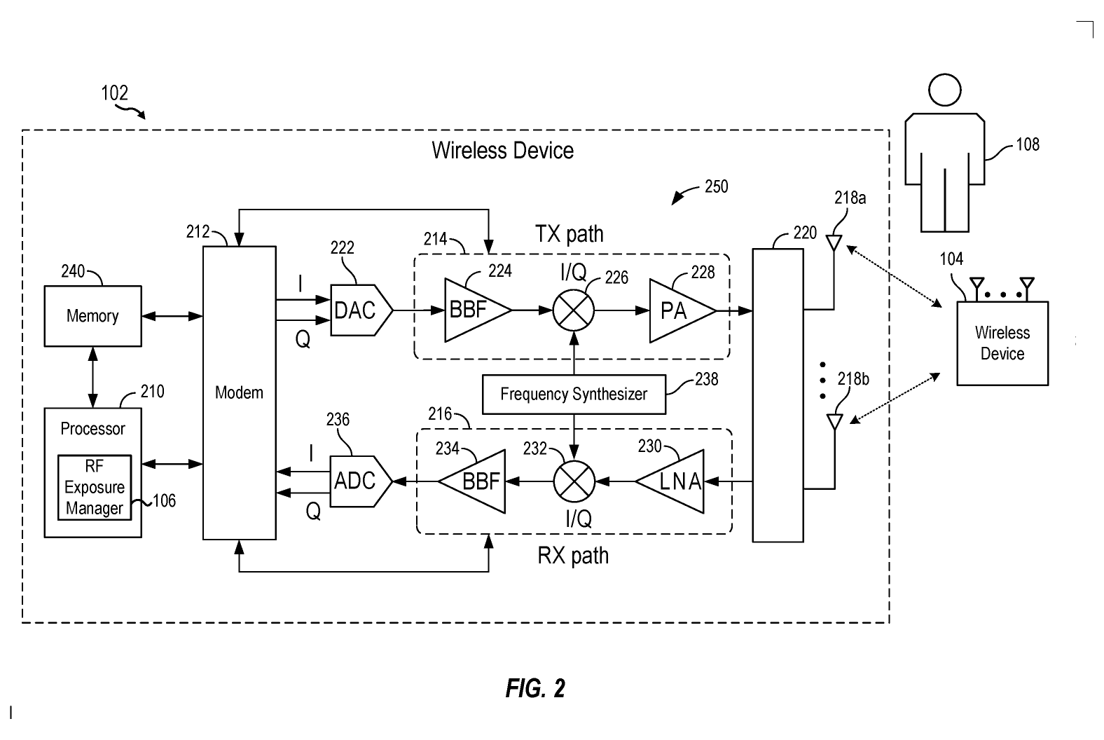

FIG. 2 illustrates example components of the wireless device 102, which may be used to communicate with any of the wireless devices 104, in some cases, in proximity to human tissue as represented by the human 108.

The wireless device 102 may be, or may include, a chip, system on chip (SoC), chipset, package or device that includes one or more modems 212. In some cases, the modem(s) 212 may include, for example, any of a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the wireless device 102 also includes one or more radios (collectively “the radio(s) 250”). In some aspects, the wireless device 102 further includes one or more processors, processing blocks, or processing elements (collectively “the processor 210”) and one or more memory blocks or elements (collectively “the memory 240”).

In certain aspects, the processor 210 may include a processor that is representative of an application processor that generates information (e.g., application data such as content requests) for transmission and/or receives information (e.g., requested content) via the modem 212. In some cases, the processor 210 may include a microprocessor associated with the modem 212, which may implement the RF exposure manager 106 and/or process any of certain protocol stack layers associated with a RAT. For example, the processor 210 may process any of an application layer, packet layer, WLAN protocol stack layers (e.g., a link or MAC layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem and/or Bluetooth modem). For example, the processor 210 may be representative of at least one of the modems 212 in communication with one or more of the other modems 212.

The modem 212 may include an intelligent hardware block or device such as an application-specific integrated circuit (ASIC), among other possibilities. The modem 212 may generally be configured to implement a physical (PHY) layer. For example, the modem 212 may be configured to modulate packets and to output the modulated packets to the radio(s) 250 for transmission over a wireless medium. The modem 212 is similarly configured to obtain modulated packets received by the radio(s) 250 and to demodulate the packets to provide demodulated packets. In addition to a modulator and a demodulator, the modem 212 may further include digital signal processing (DSP) circuitry, automatic gain control (AGC), a coder, a decoder, a multiplexer, and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio(s) 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to a DAC 222.

Receiving I or Q baseband analog signals from the DAC 222, the TX path 214 may include a baseband filter (BBF) 224, a mixer 226, and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 314 are typically RF signals, which may be amplified by the PA 228 before transmission by the antenna(s) 218. The antenna(s) 218 may emit RF signals, which may be received at the wireless device 104. While one mixer 226 is illustrated, several mixers may be used to upconvert the filtered baseband signals to one or more intermediate frequencies and to thereafter upconvert the intermediate frequency signals to a frequency for transmission.

In some cases, the wireless device 102 may communicate via multiple-input, multiple-output (MIMO) signals. The wireless device 102 may transmit more than one signal via multiple antennas 218a, 218b (collectively “the antennas 218”) to the wireless device 104 through multipath propagation. As an example, a first signal may be transmitted via the first antenna 218a, and a second signal may be transmitted via the second antenna 218b via a different propagation path than the first signal. The MIMO signals may facilitate increased communication link capacity (e.g., throughput) between the wireless device 102 and the wireless device 104.

The RX path 216 may include a low noise amplifier (LNA) 230, a mixer 232, and a baseband filter (BBF) 234. RF signals received via the antenna 218 (e.g., from the wireless device 104) may be amplified by the LNA 230, and the mixer 232 (which may comprise one or several mixers) mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals (e.g., demodulating the digital signals).

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RF exposure manager 106, a microcontroller, a microprocessor, a baseband processor, a medium access control (MAC) processor, a digital signal processor, etc. The memory 240 may store data and program codes (e.g., computer-readable instructions) for performing wireless communications as described herein. The memory 240 may be external to the processor 210 and/or the modem 212 (as illustrated) and/or incorporated therein. In certain cases, the RF exposure manager 106 (as implemented via the processor 210 and/or modem 212) may determine a transmit power (e.g., corresponding to certain levels of gain(s) applied to TX path 214 including the BBF 224, the mixer 226, and/or the PA 228) that complies with an RF exposure limit set by country-specific regulations and/or international guidelines (e.g., International Commission on Non-Ionizing Radiation Protection (ICNIRP) guidelines) as described herein.

FIG. 2 shows one reference example of a transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

In certain cases, compliance with an RF exposure limit may be performed as a time-averaged RF exposure evaluation within a specified running (moving) time window associated with the RF exposure limit. The RF exposure limit may specify a time-averaged RF exposure metric (e.g., SAR and/or PD) over the running time window. As an example, the Federal Communications Commission (FCC) specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be six minutes (360 seconds) for sub-6 GHz bands, whereas the averaging time may be 2 seconds for mmWave bands (e.g., 60 GHz frequency bands).

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union, as illustrative examples. In some cases, the RF exposure limit(s) may specify the maximum allowed RF exposure that can be encountered without time averaging. In such cases, the maximum allowed RF exposure may correspond to a maximum output or transmit power that can be used by the wireless device.

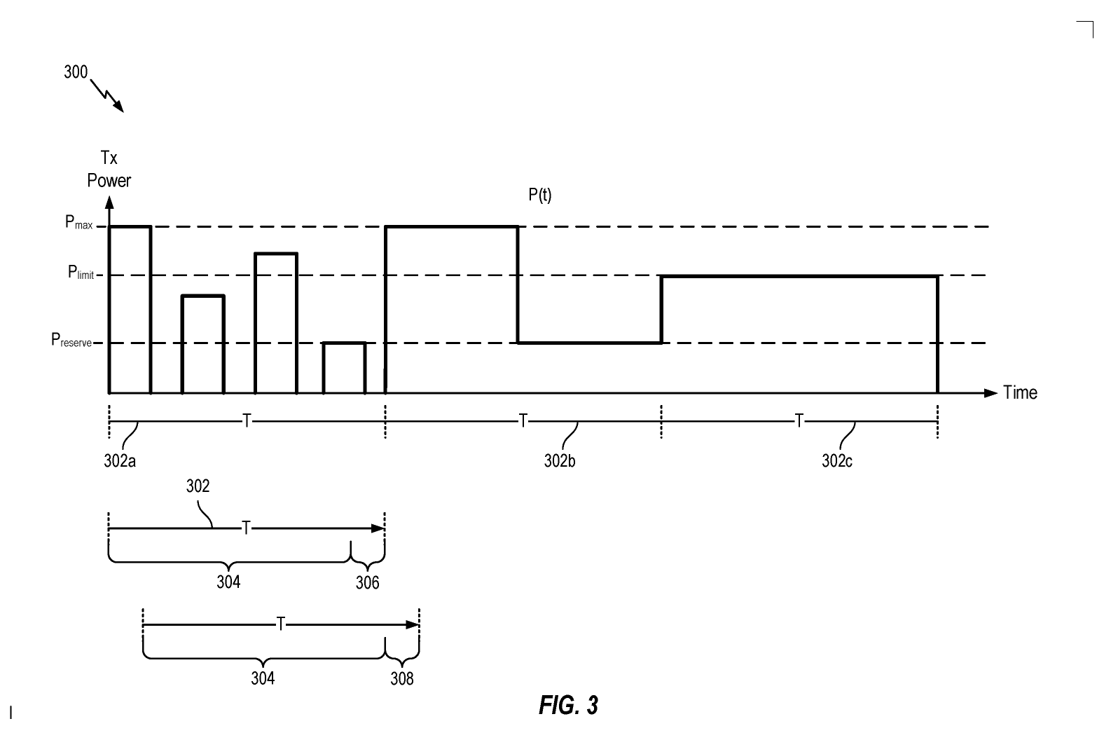

FIG. 3 is a graph 300 of a transmit power over time (P(t)) that varies over a running (e.g., rolling or moving) time window (T) associated with the RF exposure limit. The wireless device (e.g., the wireless device 102) may evaluate RF exposure compliance over the running time window 302 (T) based on past RF exposure (e.g., a transmit power report) in a past time interval 304 of the time window 302 and a future time interval 306. The wireless device may determine the maximum allowed transmit power for the future time interval 306 that satisfies the time-averaged RF exposure limit based on the past RF exposure used in the past time interval 304. The wireless device may perform such a time-averaging evaluation as the time window 302 moves over time, such as in the next future time interval 308, where the past time interval 304 now includes the previous future time interval 306 (e.g., the future time interval 306).

The maximum time-averaged transmit power limit (Pₗᵢₘᵢₜ) represents the maximum transmit power the wireless device can transmit continuously for the duration of the running time window 302 (T) in compliance with the RF exposure limit. For example, the wireless device is transmitting continuously at Pₗᵢₘᵢₜ in the time window 302c such that the time-averaged transmit power over the time window (e.g., the time window 302c) is equal to Pₗᵢₘᵢₜ in compliance with the time-averaged RF exposure limit.

In certain cases, an instantaneous transmit power may exceed Pₗᵢₘᵢₜ in certain transmission occasions, for example, as shown in the time window 302a and the time window 302b. In some cases, the wireless device may transmit at Pₘₐₓ, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, P_{CMAX}). In some cases, the wireless device may transmit at a transmit power less than or equal to Pₗᵢₘᵢₜ in certain transmission occasions, for example, as shown in the time window 302a.

In certain cases, a reserve power may be used to enable a continuous transmission within a time window (T) when transmitting above Pₗᵢₘᵢₜ in the time window or to enable a certain level of quality for certain transmissions. As shown in the time window 302b, the transmit power may be backed off from Pₘₐₓ to a reserve power (Pᵣₑₛₑᵣᵥₑ) so that the wireless device can maintain a continuous transmission during the time window (e.g., maintain a radio connection with a receiving entity) in compliance with the time-averaged RF exposure limit. In the time window 302c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling). Pᵣₑₛₑᵣᵥₑ may be used to reserve transmit power for at least a portion of the time window 302 for certain transmissions (e.g., control signaling). Pᵣₑₛₑᵣᵥₑ may also be referred to as a “control power level” or “control level.”

In the time window 302b, the area between Pₘₐₓ and Pᵣₑₛₑᵣᵥₑ for the time duration of transmitting at Pₘₐₓ may be equal to the area between Pₗᵢₘᵢₜ and Pᵣₑₛₑᵣᵥₑ for the time window T, such that the area of transmit power (P(t)) in the time window 302b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit.

In some aspects, the wireless device may transmit at a power that is higher than Pₗᵢₘᵢₜ, but less than Pₘₐₓ in the time-average mode illustrated in the time window 302b. While a single transmit burst is illustrated in the time window 302b, it will be understood that the wireless device may instead utilize a plurality of transmit bursts within the time window (T), where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user’s head, hand, or body (e.g., torso), or where the wireless device is being used as a hotspot away from human tissue. Therefore, the RF exposure can be managed as a time-averaged RF exposure evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 5 ms) of a specific period (e.g., 500 ms) in which the wireless device transmits RF signals. The duty cycle may be a ratio of the share to the specific period (e.g., 100 ms/500 ms), where the duty cycle may be represented as a number from zero to one. For example, in the time window 302a, the duty cycle may be greater than 50% of the duration of the time window (T), whereas in the time window 302b, the duty cycle may be equal to 100% of the duration of the time window (T).

In certain cases, the duty cycle may be standardized (e.g., predetermined) with a specific RAT and/or vary over time, for example, due to changes in radio conditions, mobility, and/or user behavior. As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence of slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

In some cases, a controller (e.g., a WWAN modem) may control the RF exposure exhibited by WWAN radios (including associated links thereof) in addition to other radios (e.g., WLAN radio(s) and/or Bluetooth radio(s)) (including associated links thereof).

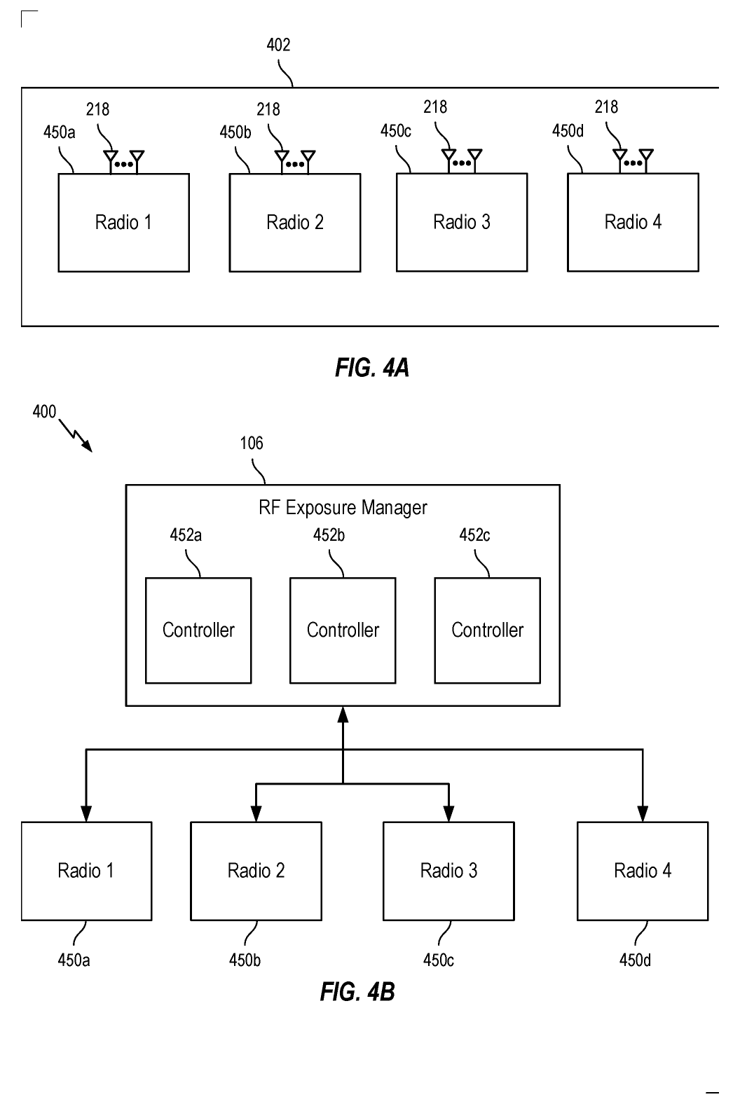

FIG. 4A is a diagram illustrating an example wireless device 402 (e.g., the wireless device 102) having multiple radios 450a-450d (collectively, “the radios 450”). The radios 450 may be similar to the radio(s) 250 of the wireless device 102 depicted in FIG. 2. In the example depicted in FIG. 4A, the radios 450a-450d may be associated with any of various RATs, communication links, and/or frequency bands. For example, the radio 450a (or radio 1) may communicate via WWAN RAT(s) (e.g., E-UTRA and/or 5G NR) in sub-6 GHz frequency bands. The radio 450b (or radio 2) may communicate via WWAN RAT(s) (e.g., 5G NR) in mmWave frequency bands. The radio 450c (or radio 3) may communicate via WLAN RAT(s) in sub-6 GHz (e.g., 2.4 GHz, 5 GHz, and/or 6 GHz) frequency bands. The radio 450d (or radio 4) may communicate via short-range communications (e.g., Bluetooth) in a 2.4 GHz frequency band. Additionally, in certain examples, one or more of the radios 450a-450d may communicate via one or more respective communication links on one or more respective frequency bands. For example, the radio 450a may communicate via a first communication link on a first sub-6 GHz frequency band, a second communication link on a second sub-6 GHz frequency band, and so on. The radio 450b may communicate via a first communication link on a first mmWave frequency band, a second communication link on a second mmWave frequency band, and so on. The radio 450c may communicate via a first communication link on the 2.4 GHz band, a second communication link on the 5 GHz band, a third communication link on the 6 GHz band, and so on. The radio 450d may communicate via a first communication link on a first frequency band used for short-range communications, via a second communication link on a second frequency band used for short-range communications, and so on. While this example shows a wireless device having four radios, a wireless device may have any number of radios for wireless communications, such as a radio per frequency band associated with WWAN and/or WLAN communications, a radio per RAT, or a radio capable of communicating via multiple RATs, as illustrative, non-limiting examples. Additionally, any radio of the wireless device may be associated with any number of communication links for one or more frequency bands of one or more RATs. Further, while the radios are illustrated as being separate, two or more of the radios may share components or circuitry. For example, portions of a signal path may be shared. The shared portion may include a shared or common mixer, filter, amplifier, and/or ADC or DAC, etc.

FIG. 4B is a diagram illustrating an example logical architecture 400 for controlling the transmit power (and hence, the RF exposure) associated with one or more radios (e.g., the radios 450a-450d) of a wireless device (e.g., the wireless device 404) (including one or more associated communication links thereof). The RF exposure manager 106 may operate as a primary controller for controlling the RF exposure associated with the radios 450a-450d. The primary controller may be a central controller for determining the maximum allowed transmit powers that can be used for a future time interval based on past transmit powers associated with all of the radios 450a-450d. For example, the RF exposure manager 106 may periodically (e.g., every 500 milliseconds (ms)) receive certain information from the radios 450a-450d, where the information may include, for example, a requested transmit power or exposure margin for a future time interval (e.g., the time interval 306, 308) and/or past transmit power history associated with a time interval (e.g., the past time interval 304) and/or averaging time window (e.g., the time window 302) or indication of whether a radio was on (active) or transmitting during the time interval and/or averaging time window. The RF exposure manager 106 may periodically (e.g., every 500 ms) provide each of the radios with an RF exposure margin or maximum allowed transmit power for a future time interval (e.g., the future time interval 306, 308).

The primary controller may include any of a number of controllers (e.g., the controller 452a, the controller 452b, and/or the controller 452c). The controller 452a may represent the WWAN modem, the controller 452b may represent the WLAN modem, and the controller 452c may represent the Bluetooth modem, for example. Thus, while the controllers 452 are illustrated separate from the radios 450, the controllers 452 and/or certain functionality thereof may be included within or integrated with respective radios 450. The controllers 452 are illustrated as being within the RF exposure manager 106, but one or more of the controllers 452 may be implemented external to the RF exposure manager 106. Further, while certain of the controllers 452 are described as being associated with or configured to implement functionality of a particular radio and/or RAT, one or more of the controllers 452 may be agnostic with respect to radios and/or RATs, and/or may be shared by multiple radios. For example, a controller 452 may be included in an applications processor.

In some cases, a controller may take control of its own power limit and operate in a standalone manner (or mode) in response to the primary controller being in a particular state (e.g., idle mode, inactive, sleep mode, low power state, etc.). For example, when the controller 452a switches to a sleep or idle mode (e.g., due to the wireless device switching to reduced power mode), the controller 452b may operate in a standalone mode controlling the RF exposure associated with the radio 450c, and in some cases, the controller 452c may operate in standalone mode controlling the RF exposure associated with the radio 450d.

The primary controller (e.g., the controller 452a) may provide the other controllers 452b, 452c with certain information. For example, the primary controller may indicate to the other controllers that the primary controller is going to a state where the primary controller can no longer operate as the primary controller (for a particular or indefinite time). Additionally, the primary controller may indicate to the other controllers a respective transmit power budget (e.g., RF exposure budget or RF exposure margin) that applies for the radio(s) and/or RAT(s) while the primary controller is unable to operate as the primary controller (e.g., for the particular or indefinite time). The transmit power budget may be allocated to each radio and/or RAT in a manner to ensure compliance with the RF exposure limit. In general, the cumulative target powers associated with the radio(s) and/or RAT(s) may satisfy the RF exposure limit. For example, the controller 452b (and/or radio(s) 450 associated therewith) may be allocated 60% of the RF exposure budget for a given time window, and the controller 452c (and/or radio(s) 450 associated therewith) may be allocated 40% of the RF exposure budget for the time window.

The primary controller may instruct the other controllers to use specific RF exposure calculations—for example, an RF exposure compliance algorithm (e.g., time-averaging or a particular maximum transmit power) with a preset parameter (e.g., RF exposure budget or transmit power level)—to control each of the other controllers’ own power limits in a standalone manner. The RF exposure compliance algorithm may be the same or different among the controllers. For example, the complexity of the algorithms or calculations may be considered when instructing the controllers. It may be unnecessary for certain controllers to evaluate the same number of and/or type of criteria, and/or the controllers may have varying capabilities.

### Example Radio Frequency Exposure Compliance among Radios in Reduced Power Mode

As noted, in some cases, when a wireless device is operating in a reduced power mode (e.g., WoW mode), the primary controller may not be able to communicate with one or more radios of the wireless device to manage the RF exposure of the radio(s) (including associated communication links thereof) in compliance with an RF exposure limit. In such cases, the radio(s) may operate according to a fixed RF exposure budget (e.g., fixed transmit power budget) provided by the primary controller, e.g., prior to the wireless device entering the reduced power mode. While the wireless device is operating in the reduced power mode, the radio(s) may still perform certain activities, such as receiving/responding to packets from other devices, to allow the wireless device to determine whether a wake condition (or trigger) is present. For example, if the radio(s) receive a “magic” wake packet from another device, then the wireless device may transition from the reduced power mode to a normal mode, in which the primary controller may resume managing the RF exposure of the radio(s) in compliance with the RF exposure limit.

However, in some cases, the communication activity of the radio(s) and/or the communication activity of one or more communication links of the radio(s) when the wireless device is operating in the reduced power mode may cause the radio(s) to have reduced performance (e.g., in cases where the radio(s) and/or communication link(s) associated with the radio(s) exceed the fixed RF exposure budget during one or more time intervals in which the wireless device is in the reduced power mode). Additionally, in some cases, the communication activity of the radio(s) and/or the communication activity of one or more communication links of the radio(s) when the wireless device is operating in the reduced power mode may cause the wireless device to violate RF exposure compliance (e.g., in cases where multiple radios and/or multiple communication links associated with the radios are transmitting in the same time interval(s) in which at least a subset of the radios have exceeded the fixed RF exposure budget allocated to the subset).

Aspects of the present disclosure provide apparatus and methods for providing RF exposure compliance among one or more radios, for example operating in a wireless device while the wireless device is in a reduced power mode, such as WoW mode. In certain aspects, when the wireless device determines that a given radio(s) and/or given communication link(s) of the radio(s) satisfies certain criteria during the reduced power mode, the wireless device may perform one or more actions to reduce the transmit power usage of the radio(s) and/or communication link(s) of the radio(s) while the wireless device is in the reduced power mode.

The criteria may include, for example, a determination that there is unlikely to be a sufficient amount of power reserved for future communications during the time interval(s) in which the wireless device is in the reduced power mode, a determination that the power usage over a past portion of the time interval (in relation to how much time of the time interval has elapsed) is disproportionate, or a combination thereof. The action(s) for reducing the transmit power usage of the radio(s) and/or communication link(s) of the radio(s) may include, for example, refraining from responding to one or more types of packets (e.g., multicast packets, broadcast packets, etc.) via the radio(s), reducing a transmission power used for transmitting one or more packets via the radio(s), reducing a duty cycle of a transmitter of the wireless device, evaluating other links that can be used for transmission activity with lower transmit power, selecting or switching to one or more of the other links, based on the evaluation, reducing a duty cycle of a transmitter of the wireless device for the new link that has been selected or switched to, or a combination thereof.

The apparatus and methods for providing RF exposure compliance among radios and/or communication links of the radios of a wireless device while the wireless device is in a reduced power mode may provide various advantages. For example, performing actions to reduce the transmit power usage of radio(s) when certain criteria are satisfied may allow certain radios (including associated communication links thereof) to transmit RF signals in compliance with RF exposure limits when the wireless device is in the reduced power mode, allow certain radios (including associated communication links thereof) to improve wireless communication performance (e.g., increased throughput, decreased latency, and/or increased transmission range) when the wireless device is in the reduced power mode, allow the wireless device to avoid violations of RF exposure compliance when the wireless device is in the reduced power mode, or combinations thereof.

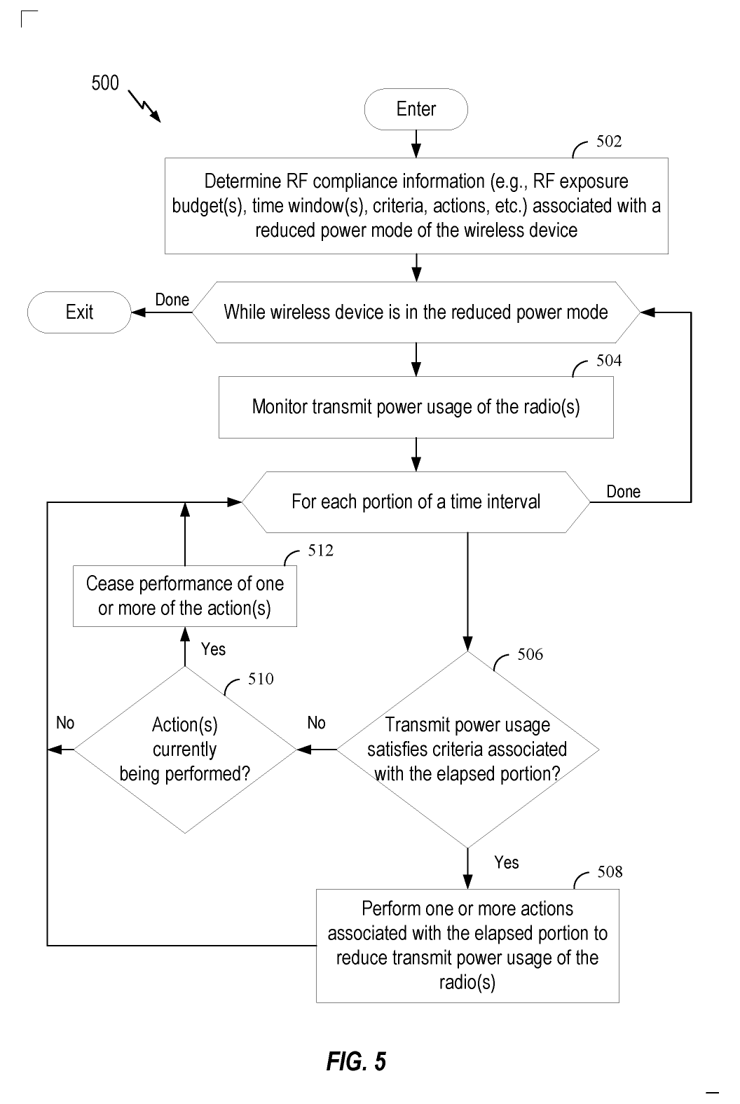

FIG. 5 is a flow diagram illustrating example operations 500 for RF exposure compliance when a wireless device is in a reduced power mode, in accordance with certain aspects of the present disclosure. The operations 500 may be performed by a wireless device (e.g., the wireless device 102, the wireless device 402, etc.).

The operations 500 may begin at block 502, where the wireless device determines RF compliance information associated with a reduced power mode (e.g., WoW mode) of the wireless device. The RF compliance information may include fixed RF exposure budget(s), an indication of the time intervals(s) associated with the RF exposure budget(s), various criteria associated with lack of compliance with an RF exposure limit, various actions for reducing transmit power usage in order to comply with the RF exposure limit, or any combination thereof.

In certain aspects, the RF compliance information may be specified for each radio, communication link, and/or RAT of the wireless device. For example, the RF compliance information may include a respective fixed RF exposure budget for each radio, communication link, and/or RAT of the wireless device, a respective set of criteria (associated with lack of compliance with the RF exposure limit) for each radio, communication link, and/or RAT, a respective set of actions (for reducing transmit power usage) for each radio, communication link, and/or RAT, or any combination thereof, or the RF compliance information may include such respective RF exposure budget, set of criteria, and/or set of actions for a subset of radio(s), communication link(s), and/or RAT(s).

The respective fixed RF exposure budget for each radio, communication link, and/or RAT may include a fixed transmit power budget for the radio, communication link, and/or RAT. In some examples, the fixed transmit power budget may be a certain percentage of an RF exposure budget (e.g., transmit power budget) associated with an RF exposure limit (e.g., X% of the RF exposure limit in terms of SAR or PD).

The respective fixed RF exposure budget for each radio, communication link, and/or RAT may apply for each time interval (T) of a time window in which the wireless device is in the reduced power mode. For example, the fixed RF exposure budget for radio 1 (e.g., radio 450a), one or more communication links associated with radio 1, and/or a first RAT (e.g., WLAN) may be expressed as X% of the RF exposure budget for an RF exposure limit in terms of SAR or PD for each 500 ms of time (or some other time interval) in which the wireless device is in the reduced power mode. Note, in some cases, the time intervals used for the fixed RF exposure budgets may be the same or different among radios/communication links/RATs. For example, a first time interval (having a first duration) may be used for the fixed RF exposure budget for a first radio/first communication link(s)/first RAT, a second time interval (having a second duration) may be used for the fixed RF exposure budget for a second radio/second communication link(s)/second RAT, and so on.

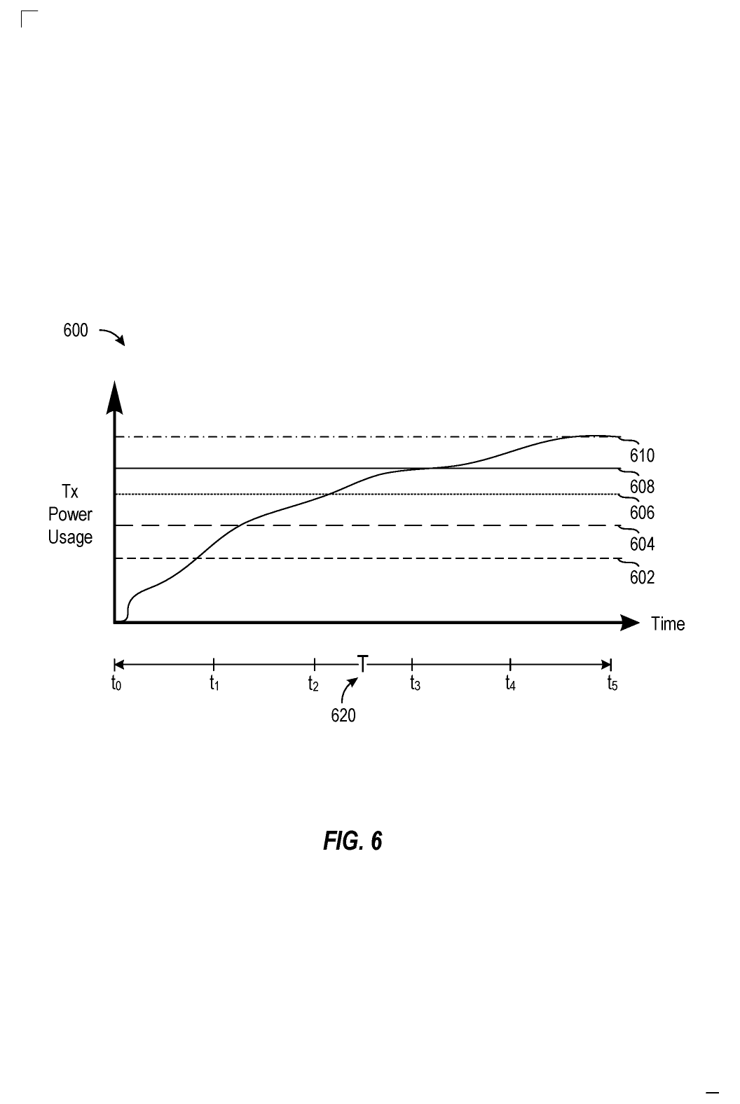

The respective set of criteria for each radio, communication link, and/or RAT may include (or may otherwise be based on) one or more different thresholds for predicting that the radio, communication link, and/or RAT will not be in compliance with the RF exposure limit during the time interval. In certain aspects, multiple thresholds may be predefined, where each threshold is associated with a different elapsed duration (or portion) of the time interval. Each threshold may be a certain percentage of the fixed RF exposure budget (e.g., fixed transmit power usage) With reference to the diagram 600 illustrating an example RF exposure compliance over time, a threshold 602 may be used to evaluate the transmit power usage of the radio, communication link, and/or RAT at a first instance of time (t₁) during a time interval (T) 620, a threshold 604 may be used to evaluate the transmit power usage of the radio, communication link, and/or RAT at a subsequent, second instance of time (t₂) during the time interval (T) 620, a threshold 606 may be used to evaluate the transmit power usage of the radio, communication link, and/or RAT at a subsequent, third instance of time (t₃) during the time interval (T) 620, a threshold 608 may be used to evaluate the transmit power usage of the radio, communication link, and/or RAT at a subsequent, fourth instance of time (t₄) during the time interval (T) 620, a threshold 610 may be used to evaluate the transmit power usage of the radio, communication link, and/or RAT at a subsequent, fifth instance of time (t₅) during the time interval (T) 620, and so on. Note that while FIG. 6 illustrates an example with 5 thresholds during a time interval, aspects of the present disclosure may use any number of thresholds for criteria associated with lack of compliance with an RF exposure limit.

The respective set of actions (for reducing transmit power usage) for each radio, communication link, and/or RAT may include one or more actions that have an impact on the transmit power usage of the radio, communication link, and/or RAT. Such actions may include refraining from responding to one or more types of packets from a same sender when a response has been previously sent to the sender, reducing a transmission power used for transmitting one or more packets, and reducing a duty cycle of a transmitter of the wireless device, as illustrative, non-limiting examples.

In certain aspects, the respective set of actions for each radio and/or communication link may include multiple actions, where each action(s) corresponds to a different threshold for criteria associated with lack of compliance with an RF exposure limit. For example, for a given radio, communication link, and/or RAT, a first one or more actions may be performed based on the threshold 602, a second one or more actions may be performed based on the threshold 604, a third one or more actions may be performed based on the threshold 606, a fourth one or more actions may be performed based on the threshold 608, a fifth set of actions may be performed based on the threshold 610, and so on. In certain aspects, the action(s) may be progressively more severe (in terms of impact on the transmit power usage of the radio, communication link, and/or RAT) with each successive threshold. Continuing with the above example in FIG. 6, the actions may be ranked from the first action(s), to second action(s), to third action(s), to fourth action(s), to fifth action(s) in ascending order of impact on the transmit power usage (e.g., amount of reduction of the transmit power usage) of the radio, communication link, and/or RAT.

In certain aspects, the RF compliance information may be specified for groups of radios, groups of communication links, and/or groups of RATs. For example, the RF compliance information may include a respective fixed RF exposure budget for each group of radios, communication links, and/or RATs (e.g., fixed RF exposure budget for WWAN radios, communication links of WWAN radios, and/or WWAN RATs, a fixed RF exposure budget for WLAN radios, communication links of WLAN radios, and/or WLAN RATs, a fixed RF exposure budget for Bluetooth radios, communication links of Bluetooth radios, and/or Bluetooth RATs, etc.), a respective set of criteria (associated with lack of compliance with the RF exposure limit) for each group of radios, group of communication links, and/or group of RATs (e.g., a first set of criteria for WWAN radios, communication links of WWAN radios, and/or WWAN RATs, a second set of criteria for WLAN radios, communication links of WLAN radios, and/or WLAN RATs, a third set of criteria for Bluetooth radios, communication links of Bluetooth radios, and/or Bluetooth RATs, etc.), a respective set of actions (for reducing transmit power usage) for each group of radios, group of communication links, and/or group of RATs (e.g., a first set of actions for WWAN radios, communication links of WWAN radios, and/or WWAN RATs, a second set of actions for WLAN radios, communication links of WLAN radios, and/or WLAN RATs, a third set of actions for Bluetooth radios, communication links of Bluetooth radios, and/or Bluetooth RATs, etc.), or any combination thereof.

In certain aspects, the RF compliance information may be specified for all radios, communication links, and/or RATs of the wireless device. For example, the RF compliance information may include a global fixed RF exposure budget for all radios, communication links, and/or RATs of the wireless device, a set of criteria for all radios, communication links, and/or RATs of the wireless device, a set of actions for all radios, communication links, and/or RATs of the wireless device, or any combination thereof.

Referring back to FIG. 5, one or more of the operations in blocks 504, 506, 508, 510, and 512 may be performed while the wireless device is in the reduced power mode. At block 504, the wireless device monitors transmit power usage of the radio(s) (e.g., radios 450) of the wireless device. In certain aspects, monitoring the transmit power usage of the radio(s) in block 504 may include monitoring the transmit power usage of one or more communication links associated with the radio(s). One or more of the operations in blocks 506, 508, 510, and 512 may be performed for each time interval (e.g., each time interval (T) 620) of a time window in which the wireless device is in the reduced power mode.

At block 506, the wireless device determines whether the transmit power usage over the time interval satisfies one or more criteria associated with the time interval and with a lack of compliance with an RF exposure limit. In certain aspects, the one or more criteria may include determining that the past power usage over the time interval (in relation to how much time of the time interval has elapsed) is disproportionate. For example, referring to FIG. 6, the wireless device may determine whether (i) the transmit power usage over a first elapsed portion of the time interval (e.g., portion (t₀ to t₁) of time interval (T) 620) is greater than the threshold 602 and (ii) the duration the first elapsed portion of the time interval is greater than a threshold amount of time (or threshold percentage of the time period). In some cases, assuming the threshold 602 and the threshold amount of time are expressed as percentages, the threshold 602 may be the same as or different than the threshold amount of time. For example, the threshold 602 (expressed as a percentage) may be greater than or equal to the threshold amount of time (expressed as a percentage).

In certain aspects, the wireless device may determine (at block 506) that the one or more criteria are satisfied when (i) the transmit power usage over the first elapsed portion of the time interval is greater than the threshold 602 and (ii) the duration of the first elapsed portion of the time interval is greater than the threshold amount of time (or threshold percentage of the time period). In certain aspects, the wireless device may determine (at block 506) that the one or more criteria are not satisfied when at least one of (i) the transmit power usage over the first elapsed portion of the time interval is less than (or equal to) the threshold 602 or (ii) the duration of the first elapsed portion of the time interval is less than (or equal to) the threshold amount of time (or threshold percentage of the time period).

If the wireless device determines (at block 506) that the one or more criteria are satisfied, then the operations 500 proceed to block 508. At block 508, the wireless device performs one or more actions associated with the threshold (e.g., threshold 602) used for evaluating the first elapsed portion of the time interval. The wireless device may perform the one or more actions to reduce the transmit power usage of the radio(s) and/or the communication link(s) of the radio(s) in at least a subsequent portion of the time interval. Continuing with the example in FIG. 6, assuming the transmit power usage over the first elapsed portion of the time interval satisfies the one or more criteria (based in part on threshold 602), the wireless device may perform first action(s) associated with the threshold 602 in order to reduce the transmit power usage of the radio(s) and/or the communication link(s) of the radio(s) in the subsequent portion of the time interval (e.g., portion (t₁ to t₂) of time interval (T) 620). In some examples, the first action(s) may include refraining from responding to certain types of packets, such as multicast offloaded packets, broadcast offloaded packets, if the wireless device has already responded once to the same source address. Examples of multicast/broadcast offloaded packets may include address resolution protocol (ARP) request packets and neighbor solicitation (NS) offload packets, as illustrative, non-limiting examples. In other examples, assuming the wireless device supports MLO, the first action(s) may include evaluating a set of communication links for the radio(s) that can be used for transmissions with lower transmit power than a currently used communication link used for communications.

The wireless device may continue evaluating the transmit power usage over subsequent portions of the time interval based on respective one or more criteria associated with the respective portions. Continuing with the above example in FIG. 6, assuming the transmit power usage over a second elapsed portion of the time interval (e.g., portion (t₀ to t₂)of time interval (T) 620) satisfies the one or more criteria (based in part on threshold 604), the wireless device may perform second action(s) associated with threshold 604 in order to reduce the transmit power usage of the radio(s) in the subsequent portion of the time interval (e.g., portion (t₂ to t₃) of time interval (T) 620). In some examples, the second action(s) may include reducing a transmission power used for transmitting one or more packets. In some cases, the wireless device may perform a telescoping transmit power reduction for each transmit packet. The telescoping transmit power reduction may involve reducing the per packet transmit power in smaller step sizes until the transmit power level reaches a level that is associated with reliably receiving an acknowledgment. In some examples, assuming the wireless device supports MLO, the second action(s) may include determining, based on the evaluation of the set of communication links performed during the first elapsed portion of the time interval, a communication link, from the set of communication links, that can be used for transmissions with a lower transmit power than the currently used communication link. In some cases, the communication link that is selected may be associated with a lowest transmit power among the set of communication links. In some cases, the communication link that is selected may be associated with a maximum amount of remaining transmit power for a remaining subsequent portion of the time interval (e.g., portion (t₂ to t₃) of time interval (T) 620) among the set of communication links. After determining the communication link, the wireless device may select the communication link for transmissions (assuming the wireless device has eMLSR capability) or switch to the communication link (assuming the wireless device has MLSR capability). Note, in some cases, the second action(s) may be performed in addition to the first action(s) for at least a duration of the subsequent portion of the time interval (e.g., portion (t₂ to t₃)).

Additionally, assuming the transmit power usage over a third portion of the time interval (e.g., portion (t₀ to t₃) of time interval (T) 620) satisfies the one or more criteria (based in part on threshold 606), the wireless device may perform third action(s) associated with the threshold 606 in order to reduce the transmit power usage of the radio(s) and/or the communication link(s) of the radio(s) in the subsequent portion of the time interval (e.g., portion (t₃ to t₄) of time interval (T) 620). In some examples, the third action(s) may include reducing the duty cycle of a transmitter (e.g., turning off the transmitter for some percentage of the remaining time period). In some examples, assuming the wireless device supports MLO, the third action(s) may include reducing the duty cycle of the transmitter for the new communication link that the wireless device has selected (in the case of eMLSR capability) or switched to (in the case of MLSR capability). Note, in some cases, the third action(s) may be performed in addition to the first action(s) and the second actions for at least a duration of the subsequent portion of the time interval (e.g., portion (t₃ to t₄) of time interval (T) 620).

If the wireless device determines (at block 506) that the one or more criteria are not satisfied, then the operations 500 proceed to block 510. At block 510, the wireless device determines whether one or more actions are currently being performed to reduce the transmit power usage of the radio(s). If so, then the operations 500 proceed to block 512, where the wireless device may cease performance of one or more of the action(s). For example, if the one or more criteria are not satisfied at a particular point in time during the time period (e.g., the power usage over a past portion of the time interval (in relation to how much time of the time interval has elapsed) is proportionate), then the wireless device may cease performing one or more of the actions. Continuing with the example depicted in FIG. 6, assuming the transmit power usage over a fourth elapsed portion of time interval (e.g., portion (t₀ to t₄) of time interval (T) 620) does not satisfy the one or more criteria (based in part on threshold 608), the wireless device may cease performing at least one of the third action(s), second action(s), or first action(s) in the subsequent portion of the time interval (e.g., portion (t₄ to t₅) of time interval (T) 620).

Advantageously, as noted, the apparatus and methods for providing RF exposure compliance among radios and/or communication links of the radios of a wireless device while the wireless device is in a reduced power mode may provide various advantages. For example, performing actions to reduce the transmit power usage of radio(s) when certain criteria are satisfied may allow certain radios (including associated communication links thereof) to transmit RF signals in compliance with RF exposure limits when the wireless device is in the reduced power mode, allow certain radios (including associated communication links thereof) to improve wireless communication performance (e.g., increased throughput, decreased latency, and/or increased transmission range) when the wireless device is in the reduced power mode, allow the wireless device to avoid violations of RF exposure compliance when the wireless device is in the reduced power mode, or combinations thereof.

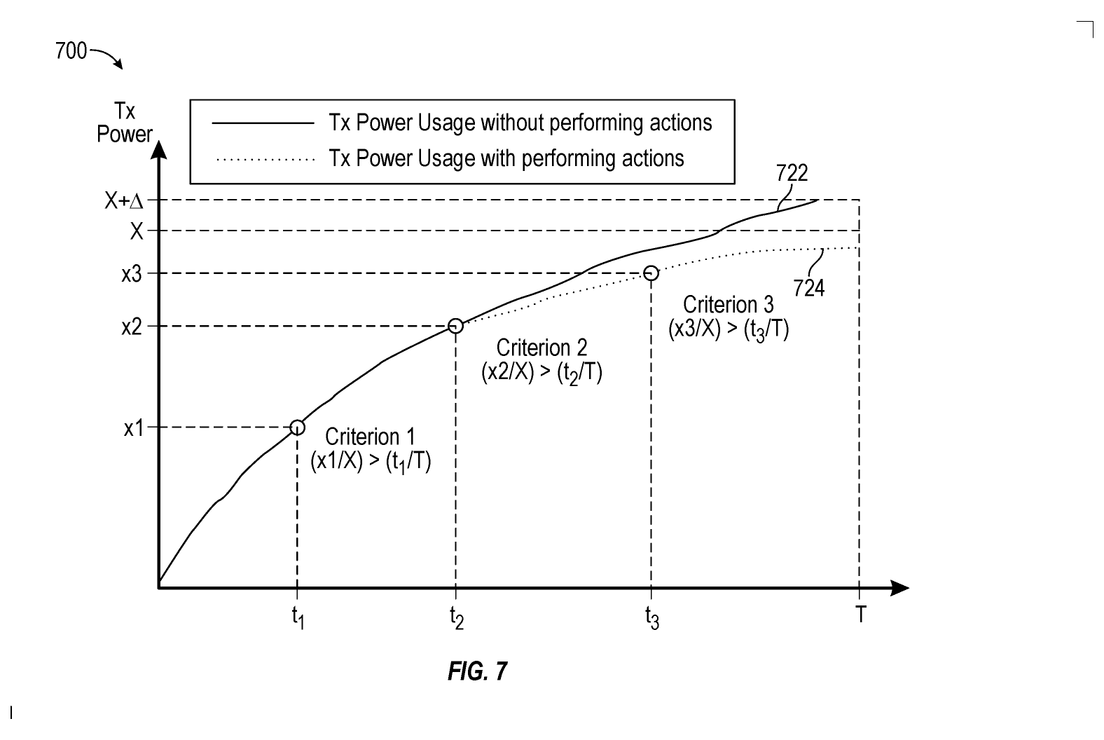

FIG. 7, for example, is a diagram 700 illustrating an example of RF exposure compliance over time when one or more techniques described herein are implemented while a wireless device is in the reduced power mode. Here, the radio, communication link, and/or RAT of a wireless device may be allocated a fixed RF exposure budget (e.g., fixed transmit power usage) (X) for a time interval (T).

As shown, after determining that a first criterion (criterion 1) (e.g., (x1/X) > (t₁/T)) is satisfied at a first time instance (t₁), the wireless device may perform a first set of actions to reduce the transmit power usage 724 of the radio, communication link, and/or RAT. Subsequently, after determining that a second criterion (criterion 2) (e.g., (x2/X) > (t₂/T)) is satisfied at a second time instance (t₂), the wireless device may perform a second set of actions to reduce the transmit power usage 724 of the radio, communication link, and/or RAT. Subsequently, after determining that a third criterion (criterion 3) (e.g., (x3/X) > (t₃/T)) is satisfied at a third time instance (t₃), the wireless device may perform a third set of actions to reduce the transmit power usage 724 of the radio, communication link, and/or RAT.

Consequently, as shown in FIG. 7, compared to the transmit power usage 722 of the radio, communication link, and/or RAT, the transmit power usage 724 may be in compliance with (e.g., less than or equal to) the fixed RF exposure budget (X) when the wireless device is in the reduced power mode.

### Example Operations

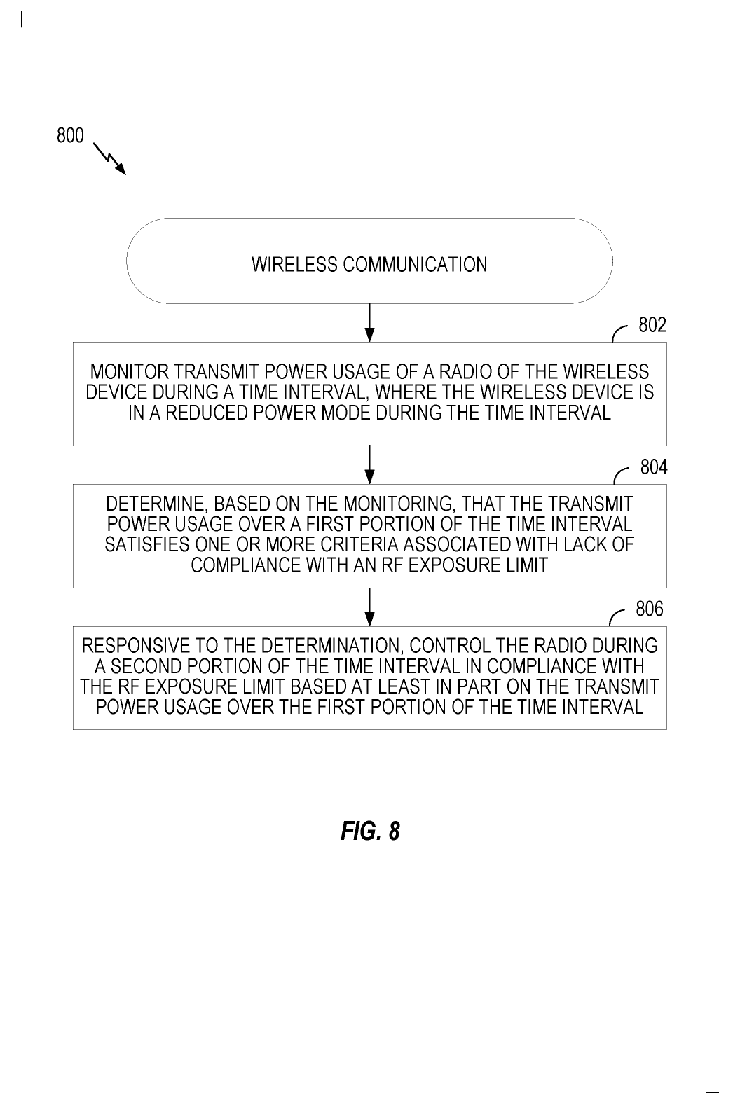

FIG. 8 is a flow diagram illustrating example operations 800 for wireless communication. The operations 800 may be performed, for example, by a wireless device (e.g., the wireless device 102 in the wireless communication system 100). The operations 800 may be implemented as software components that are executed and run on one or more processors (e.g., the processor 210 and/or the modem 212 of FIG. 2). Further, the transmission and/or reception of signals by the wireless device in the operations 800 may be enabled, for example, by one or more antennas (e.g., antennas 218 of FIG. 2). In certain aspects, the transmission and/or reception of signals by the wireless device may be implemented via a bus interface of one or more processors (e.g., the processor 210 and/or the modem 212) obtaining and/or outputting signals for reception or transmission.

The operations 800 may optionally begin, at block 802, where the wireless device may monitor transmit power usage of a radio (e.g., radio 450) of the wireless device during a time interval (e.g., time interval (T) 620). The wireless device may be in a reduced power mode (e.g., WoW mode) during the time interval; further, the monitoring may be dependent on or triggered by a determination that the device is operating in the reduce power mode (e.g., WoW mode). In certain aspects, monitoring the transmit power usage of the radio in block 802 may include monitoring the transmit power usage of one or more communication links associated with the radio.

At block 804, the wireless device determines, based on the monitoring, that the transmit power usage over a first portion of the time interval (e.g., portion (t₀ to t₁) of time interval (T) 620) satisfies one or more (first) criteria associated with lack of compliance with an RF exposure limit.

At block 806, the wireless device, responsive to the determination, controls the radio during a second portion of the time interval (e.g., portion (t₁ to t₂) of time interval (T) 620) in compliance with the RF exposure limit based at least in part on the transmit power usage over the first portion of the time interval. In certain aspects, to control the radio (in block 806), the wireless device may control one or more communication links associated with the radio.

In some aspects, to control the radio during the second portion of the time interval, the wireless device may perform one or more actions to reduce the transmit power usage of the radio over the second portion of the time interval. The one or more actions may include (i) refraining from responding to one or more types of packets from a same sender when a response has been previously sent to the sender, (ii) reducing a transmission power used for transmitting one or more packets, (iii) reducing a duty cycle of a transmitter of the wireless device, or (iv) any combination thereof. In some examples, the one or more types of packets may include multicast packets, broadcast packets, ARP request packets, NS offload packets, or any combination thereof.

In some aspects, to control the radio during the second portion of the time interval, the wireless device may perform one or more actions to reduce a transmit power usage of at least a first communication link associated with the radio over the second portion of the time interval. The one or more actions may include: (i) determining, for each communication link in a set of communication links, a respective transmit power level that can be used for transmissions on the communication link; (ii) based on the determination, (a) switching from the first communication link to a second communication link among the set of communication links (in the case of MLSR capability) or (b) selecting the second communication link among the set of communication links (in the case of eMLSR capability), the second communication link being associated with a lower transmit power level than the first communication link; (iii) reducing a duty cycle of a transmitter of the wireless device on the second communication link; or (iv) any combination thereof.

In some aspects, the one or more (first) criteria (in block 804) may include (i) the transmit power usage over the first portion of the time interval being greater than a first threshold (e.g., threshold 602) and (ii) the first portion of the time interval being greater than or equal to a second threshold (e.g., threshold amount of time or threshold percentage of the time interval). In certain aspects, the transmit power usage and the first portion of the time interval are expressed as percentages and the first threshold is greater than or equal to the second threshold.

In some aspects, the transmit power usage over the first portion of the time interval uses an amount of a transmit power budget reserved for communications during the time interval. In such aspects, the one or more (first) criteria (in block 804) may include a remaining amount of the transmit power budget being less than a threshold.

In some aspects, the operations 800 may further involve the wireless device (i) determining, based on the monitoring, that the transmit power usage over the first and second portions of the time interval (e.g., portion (t₀ to t₂) of the time interval (T) 620) satisfies one or more (second) criteria associated with lack of compliance with the RF exposure limit, and (ii) responsive to the determination that the transmit power usage over the first and second portions of the time interval satisfies the one or more (second) criteria, controlling the radio during a third portion of the time interval (e.g., portion (t₂ to t₃) of the time interval (T) 620) in compliance with the RF exposure limit based at least in part on the transmit power usage over the first and second portions of the time interval.

Additionally, in such aspects, the operations 800 may further involve the wireless device (i) determining, based on the monitoring, that the transmit power usage over the first, second, and third portions of the time interval (e.g., portion (t₀ to t₃) of time interval (T) 620) does not satisfy one or more third criteria associated with lack of compliance with the RF exposure limit, and (ii) responsive to the determination that the transmit power usage over the first, second, and third portions of the time interval does not satisfy the one or more third criteria, ceasing performance of at least one of the one or more first actions or the one or more second actions over a fourth portion of the time interval (e.g., portion (t₃ to t₄) of time interval (T) 620).

To control the radio during the second portion of the time interval, the wireless device may perform one or more first actions to reduce the transmit power usage of the radio over the second portion of the time interval. Additionally, to control the radio during the third portion of the time interval, the wireless device may perform one or more second actions to reduce the transmit power usage of the radio over the third portion of the time interval. The one or more second actions may have a greater impact on the transmit power usage of the radio than the one or more first actions.

The one or more first criteria may include (i) the transmit power usage over the first portion of the time interval being greater than a first threshold and (ii) the first portion of the time interval being greater than or equal to a second threshold. The one or more second criteria may include (i) the transmit power usage over the first and second portions of the time interval being greater than a third threshold and (ii) the first and second portions of the time interval being greater than or equal to a fourth threshold. The one or more third criteria may include (i) the transmit power usage over the first, second, and third portions of the time interval being greater than a fifth threshold and (ii) the first, second, and third portions of the time interval being greater than or equal to a sixth threshold.

### Example Communications Device

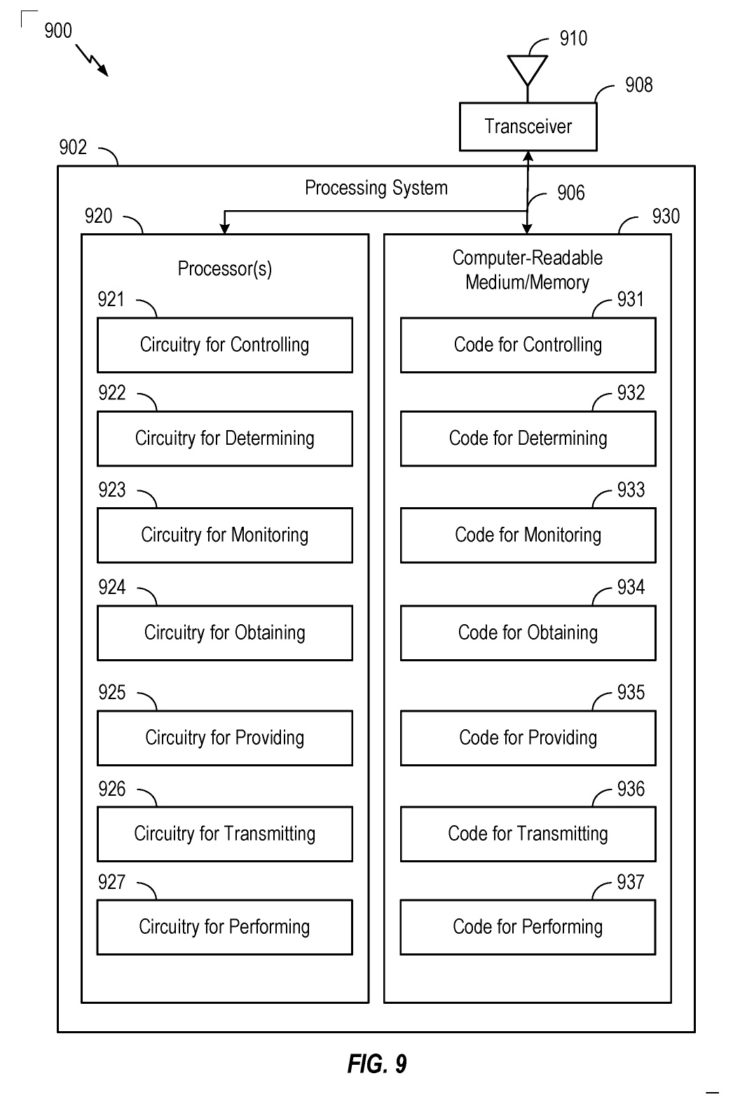

FIG. 9 depicts aspects of an example communications device 900. In some aspects, communications device 900 is a wireless communication device, such as the wireless device 102 described above with respect to FIGS. 1 and 2.

The communications device 900 includes a processing system 902 coupled to a transceiver 908 (e.g., a transmitter and/or a receiver). The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes one or more processors 920. In various aspects, the one or more processors 920 may be representative of any of the processor 210 and/or the modem 212, as described with respect to FIG. 2. The one or more processors 920 are coupled to a computer-readable medium/memory 930 via a bus 906. In certain aspects, the computer-readable medium/memory 930 is configured to store instructions (e.g., computer-executable code) that when executed by the one or more processors 920, cause the one or more processors 920 to perform the operations 500 described with respect to FIG. 5, the operations 800 described with respect to FIG. 8, or any aspect related to the operations described herein. Note that reference to a processor performing a function of communications device 900 may include one or more processors performing that function of communications device 900.

In the depicted example, computer-readable medium/memory 930 stores code (e.g., executable instructions) for controlling 931 (including code for operating, code for refraining, code for selecting, code for switching, and code for ceasing), code for determining 932 (including code for detecting and code for evaluating), code for monitoring 933, code for obtaining 934, code for providing 935, code for transmitting 936, and code for performing 937. Processing of the code 931-937 may cause the communications device 900 to perform the operations 500 described with respect to FIG. 5, the operations 800 described with respect to FIG. 8, or any aspect related to operations described herein.

The one or more processors 920 include circuitry configured to implement (e.g., execute) the code stored in the computer-readable medium/memory 930, including circuitry for controlling 921 (including circuitry for operating, circuitry for ceasing, circuitry for selecting, circuitry for switching, and circuitry for refraining), circuitry for determining 922 (including circuitry for detecting and circuitry for evaluating), circuitry for monitoring 923, circuitry for obtaining 924, circuitry for providing 925, circuitry for transmitting 926, and circuitry for performing 927. Processing with circuitry 921-927 may cause the communications device 900 to perform the operations 500 described with respect to FIG. 5, the operations 800 described with respect to FIG. 8, or any aspect related to operations described herein.

Various components of the communications device 900 may provide means for performing the operations 500 described with respect to FIG. 5, the operations 800 described with respect to FIG. 8, or any aspect related to operations described herein. For example, means for transmitting, sending or outputting for transmission may include the TX path 214 and/or antenna(s) 218 of the wireless device 102 illustrated in FIG. 2 and/or transceiver 908 and antenna 910 of the communications device 900 in FIG. 9. Means for receiving or obtaining may include the RX path 216 and/or antenna(s) 218 of the wireless device 102 illustrated in FIG. 2, and/or transceiver 908 and antenna 910 of the communications device 900 in FIG. 9. Means for controlling, means for performing, means for operating, means for selecting, means for switching, means for evaluating, means for ceasing, means for refraining, means for determining, means for detecting, means for monitoring, means for comparing, means for obtaining, and/or means for providing may include a processor, such as the processor 210 and/or modem 212 depicted in FIG. 2 and/or the processor(s) 920 in FIG. 9.

### Example Aspects

### Implementation examples are described in the following numbered clauses:

Aspect 1: A method of wireless communication by a wireless device, comprising: monitoring transmit power usage of a radio of the wireless device during a time interval, wherein the wireless device is in a reduced power mode during the time interval; determining, based on the monitoring, that the transmit power usage over a first portion of the time interval satisfies one or more first criteria associated with lack of compliance with a radio frequency (RF) exposure limit; and responsive to the determination, controlling the radio during a second portion of the time interval in compliance with the RF exposure limit based at least in part on the transmit power usage over the first portion of the time interval.

Aspect 2: The method of Aspect 1, wherein controlling the radio during the second portion of the time interval comprises performing one or more actions to reduce the transmit power usage of the radio over the second portion of the time interval.

Aspect 3: The method of Aspect 2, wherein the one or more actions comprise: refraining from responding to one or more types of packets from a same sender when a response has been previously sent to the sender; reducing a transmission power used for transmitting one or more packets; reducing a duty cycle of a transmitter of the wireless device; or any combination thereof.

Aspect 4: The method of Aspect 3, wherein the one or more types of packets comprise multicast packets, broadcast packets, or any combination thereof.

Aspect 5: The method according to any of Aspects 3-4, wherein the one or more types of packets comprise at least one of an address resolution protocol (ARP) request packet or a neighbor solicitation (NS) offload packet.

Aspect 6: The method according to any of Aspects 1-5, wherein controlling the radio during the second portion of the time interval comprises performing one or more actions to reduce a transmit power usage of at least a first communication link associated with the radio over the second portion of the time interval.

Aspect 7: The method of Aspect 6, wherein the one or more actions comprise: determining, for each communication link in a set of communication links, a respective transmit power level that can be used for transmissions on the communication link; based on the determination, (i) switching from the first communication link to a second communication link among the set of communication links or (ii) selecting the second communication link among the set of communication links, the second communication link being associated with a lower transmit power level than the first communication link; reducing a duty cycle of a transmitter of the wireless device on the second communication link; or any combination thereof.

Aspect 8: The method according to any of Aspects 1-7, wherein the one or more first criteria comprise (i) the transmit power usage over the first portion of the time interval being greater than a first threshold and (ii) the first portion of the time interval being greater than or equal to a second threshold.

Aspect 9: The method according to any of Aspects 1-8, wherein the transmit power usage and the first portion of the time interval are expressed as percentages and wherein the first threshold is greater than or equal to the second threshold.

Aspect 10: The method according to any of Aspects 1-9, wherein: the transmit power usage over the first portion of the time interval uses an amount of a transmit power budget reserved for communications during the time interval; and the one or more first criteria comprise a remaining amount of the transmit power budget being less than a threshold.

Aspect 11: The method according to any of Aspects 1-10, further comprising: determining, based on the monitoring, that the transmit power usage over the first and second portions of the time interval satisfies one or more second criteria associated with lack of compliance with the RF exposure limit; and responsive to the determination that the transmit power usage over the first and second portions of the time interval satisfies the one or more second criteria, controlling the radio during a third portion of the time interval in compliance with the RF exposure limit based at least in part on the transmit power usage over the first and second portions of the time interval.

Aspect 12: The method of Aspect 11, wherein: controlling the radio during the second portion of the time interval comprises performing one or more first actions to reduce the transmit power usage of the radio over the second portion of the time interval; and controlling the radio during the third portion of the time interval comprises performing one or more second actions to reduce the transmit power usage of the radio over the third portion of the time interval.

Aspect 13: The method of Aspect 12, wherein the one or more second actions have a greater impact on the transmit power usage of the radio than the one or more first actions.

Aspect 14: The method according to any of Aspects 12-13, further comprising: determining, based on the monitoring, that the transmit power usage over the first, second, and third portions of the time interval does not satisfy one or more third criteria associated with lack of compliance with the RF exposure limit; and responsive to the determination that the transmit power usage over the first, second, and third portions of the time interval does not satisfy the one or more third criteria, ceasing performance of at least one of (i) the one or more first actions or (ii) the one or more second actions over a fourth portion of the time interval.

Aspect 15: The method of Aspect 14, wherein: the one or more first criteria comprise (i) the transmit power usage over the first portion of the time interval being greater than a first threshold and (ii) the first portion of the time interval being greater than or equal to a second threshold; the one or more second criteria comprise (i) the transmit power usage over the first and second portions of the time interval being greater than a third threshold and (ii) the first and second portions of the time interval being greater than or equal to a fourth threshold; and the one or more third criteria comprise (i) the transmit power usage over the first, second, and third portions of the time interval being greater than a fifth threshold and (ii) the first, second, and third portions of the time interval being greater than or equal to a sixth threshold.

Aspect 16: The method according to any of Aspects 1-15, wherein the reduced power mode comprises a wake-on-wireless (WoW) mode.

Aspect 17: An apparatus comprising: one or more memories collectively storing executable instructions; and one or more processors coupled to the one or more memories, the one or more processors being collectively configured to execute the executable instructions and cause the apparatus to perform a method in accordance with any of Aspects 1-16.

Aspect 18: An apparatus for wireless communications, comprising means for performing a method in accordance with any of Aspects 1-16.

Aspect 19: A non-transitory computer-readable medium comprising computer-executable instructions that, when executed by one or more processors of a processing system, cause the processing system to perform a method in accordance with any of Aspects 1-16.

Aspect 20: A computer program product embodied on a computer-readable storage medium comprising code for performing a method in accordance with any of Aspects 1-16.

### Additional Considerations

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, identifying, searching, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. A hardware module may include several electrical elements (e.g., one or more dies and/or other components) packaged together.

The various illustrative logical blocks, modules and circuits described in connection with the present disclosure may be implemented or performed with a general purpose processor, a digital signal processor (DSP), a neural network processor, a system on chip (SoC), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (random access memory), flash memory, ROM (read-only memory), PROM (programmable read-only memory), EPROM (erasable programmable read-only memory), EEPROM (electrically erasable programmable read-only memory), registers, magnetic disks, optical disks, hard drives, or any other suitable non-transitory storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein (e.g., instructions for performing the operations described herein and illustrated in FIGS. 5 and 7).

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or other physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method of wireless communication by a wireless device, comprising:
monitoring transmit power usage of a radio of the wireless device during a time interval, wherein the wireless device is in a reduced power mode during the time interval;
determining, based on the monitoring, that the transmit power usage over a first portion of the time interval satisfies one or more first criteria associated with lack of compliance with a radio frequency (RF) exposure limit; and
responsive to the determination, controlling the radio during a second portion of the time interval in compliance with the RF exposure limit based at least in part on the transmit power usage over the first portion of the time interval.

2. The method of claim 1, wherein controlling the radio during the second portion of the time interval comprises performing one or more actions to reduce the transmit power usage of the radio over the second portion of the time interval.

3. The method of claim 2, wherein the one or more actions comprise:
refraining from responding to one or more types of packets from a same sender when a response has been previously sent to the sender;
reducing a transmission power used for transmitting one or more packets;
reducing a duty cycle of a transmitter of the wireless device; or
any combination thereof.

4. The method of claim 3, wherein the one or more types of packets comprise multicast packets, broadcast packets, or any combination thereof.

5. The method of claim 3, wherein the one or more types of packets comprise at least one of an address resolution protocol (ARP) request packet or a neighbor solicitation (NS) offload packet.

6. The method of claim 1, wherein controlling the radio during the second portion of the time interval comprises performing one or more actions to reduce a transmit power usage of at least a first communication link associated with the radio over the second portion of the time interval.

7. The method of claim 6, wherein the one or more actions comprise:
determining, for each communication link in a set of communication links, a respective transmit power level that can be used for transmissions on the communication link;
based on the determination, (i) switching from the first communication link to a second communication link among the set of communication links or (ii) selecting the second communication link among the set of communication links, the second communication link being associated with a lower transmit power level than the first communication link;
reducing a duty cycle of a transmitter of the wireless device on the second communication link; or
any combination thereof.

8. The method of claim 1, wherein the one or more first criteria comprise (i) the transmit power usage over the first portion of the time interval being greater than a first threshold and (ii) the first portion of the time interval being greater than or equal to a second threshold.

9. The method of claim 8, wherein the transmit power usage and the first portion of the time interval are expressed as percentages and wherein the first threshold is greater than or equal to the second threshold.

10. The method of claim 1, wherein:
the transmit power usage over the first portion of the time interval uses an amount of a transmit power budget reserved for communications during the time interval; and
the one or more first criteria comprise a remaining amount of the transmit power budget being less than a threshold.

11. The method of claim 1, further comprising:
determining, based on the monitoring, that the transmit power usage over the first and second portions of the time interval satisfies one or more second criteria associated with lack of compliance with the RF exposure limit; and
responsive to the determination that the transmit power usage over the first and second portions of the time interval satisfies the one or more second criteria, controlling the radio during a third portion of the time interval in compliance with the RF exposure limit based at least in part on the transmit power usage over the first and second portions of the time interval.

12. The method of claim 11, wherein:
controlling the radio during the second portion of the time interval comprises performing one or more first actions to reduce the transmit power usage of the radio over the second portion of the time interval; and
controlling the radio during the third portion of the time interval comprises performing one or more second actions to reduce the transmit power usage of the radio over the third portion of the time interval.

13. The method of claim 12, wherein the one or more second actions have a greater impact on the transmit power usage of the radio than the one or more first actions.

14. The method of claim 12, further comprising:
determining, based on the monitoring, that the transmit power usage over the first, second, and third portions of the time interval does not satisfy one or more third criteria associated with lack of compliance with the RF exposure limit; and
responsive to the determination that the transmit power usage over the first, second, and third portions of the time interval does not satisfy the one or more third criteria, ceasing performance of at least one of (i) the one or more first actions or (ii) the one or more second actions over a fourth portion of the time interval.

15. The method of claim 14, wherein:
the one or more first criteria comprise (i) the transmit power usage over the first portion of the time interval being greater than a first threshold and (ii) the first portion of the time interval being greater than or equal to a second threshold;
the one or more second criteria comprise (i) the transmit power usage over the first and second portions of the time interval being greater than a third threshold and (ii) the first and second portions of the time interval being greater than or equal to a fourth threshold; and
the one or more third criteria comprise (i) the transmit power usage over the first, second, and third portions of the time interval being greater than a fifth threshold and (ii) the first, second, and third portions of the time interval being greater than or equal to a sixth threshold.

16. The method of claim 1, wherein the reduced power mode comprises a wake-on-wireless (WoW) mode.

17. An apparatus for wireless communication, comprising:
one or more memories collectively storing executable instructions; and
one or more processors coupled to the one or more memories, the one or more processors being collectively configured to execute the executable instructions to cause the apparatus to:
monitor transmit power usage of a radio of the apparatus during a time interval, wherein the apparatus is in a reduced power mode during the time interval;
determine, based on the monitoring, that the transmit power usage over a first portion of the time interval satisfies one or more first criteria associated with lack of compliance with a radio frequency (RF) exposure limit; and
responsive to the determination, control the radio during a second portion of the time interval in compliance with the RF exposure limit based at least in part on the transmit power usage over the first portion of the time interval.

18. The apparatus of claim 17, wherein to control the radio during the second portion of the time interval, the one or more processors are collectively configured to execute the executable instructions to cause the apparatus to perform one or more actions to reduce the transmit power usage of the radio over the second portion of the time interval.

19. The apparatus of claim 17, wherein to control the radio during the second portion of the time interval, the one or more processors are collectively configured to execute the executable instructions to cause the apparatus to perform one or more actions to reduce a transmit power usage of at least one communication link associated with the radio over the second portion of the time interval.

20. An apparatus for wireless communications, comprising:
means for monitoring transmit power usage of a radio of the apparatus during a time interval, wherein the apparatus is in a reduced power mode during the time interval;
means for determining, based on the monitoring, that the transmit power usage over a first portion of the time interval satisfies one or more criteria associated with lack of compliance with a radio frequency (RF) exposure limit; and
means for controlling, responsive to the determination, the radio during a second portion of the time interval in compliance with the RF exposure limit based at least in part on the transmit power usage over the first portion of the time interval.
